(19) United States
(12) Patent Application Publication
(10) Pub. No.: US 2024/0158544 A1
(43) Pub. Date: May 16, 2024

(54) COATED ARTICLE

(71) Applicant: BOREALIS AG, Vienna (AT)

(72) Inventors: Jingbo WANG, Linz (AT); Markus GAHLEITNER, Linz (AT); Klaus BERNREITNER, Linz (AT); Pauli LESKINEN, Porvoo (FI); Peter NIEDERSUESS, Linz (AT); Auli NUMMILA-PAKARINEN, Porvoo (FI); Stefan ORTNER, Linz (AT)

(73) Assignee: BOREALIS AG, Vienna (AT)

(21) Appl. No.: 18/546,325

(22) PCT Filed: Feb. 11, 2022
(86) PCT No.: PCT/EP2022/053375

§ 371 Date: Aug. 14, 2023

(30) Foreign Application Priority Data
Feb. 15, 2021 (EP) 21157177.3

(51) Int. Cl. C08F 10/06; B32B 27/08; B32B 27/32; C08J 11/04; C08L 23/12; C08L 23/14

(52) U.S. Cl. CPC C08F 10/06; B32B 27/08; B32B 27/327; C08J 11/04; C08L 23/12; C08L 23/14; B32B 2250/03; B32B 2250/242; B32B 2270/00; B32B 2307/518; B32B 2307/718; B32B 2307/7376; B32B 2439/70; B32B 2439/80; C08J 2323/12; C08J 2323/14

(57) ABSTRACT

The present invention relates to a coated article comprising at least a substrate layer (SL), a first coating layer (CL1) and a second coating layer (CL2), wherein CL2 comprises a polypropylene composition comprising (A) a polypropylene homopolymer having a melt flow rate MFR₂ (230° C./2.16 kg) measured according to ISO 1133 in the range from 10 to 40 g/10 min; a melting temperature Tₘ as determined by DSC according to ISO 11357 in the range from 149 to 162° C.; and a molecular weight distribution MWD in the range from 2.4 to 4.5 as determined by GPC; and/or (B) an ethylene propylene random copolymer having a melt flow rate MFR₂ (230° C./2.16 kg) measured according to ISO 1133 in the range from 4 to 40 g/10 min; a melting temperature Tₘ as determined by DSC according to ISO 11357 in the range from 115 to 145° C.; and a number of 2,1 and 3,1 regio defects in the range from 0.01 to 1.2 mol-% as measured by ¹³C NMR; and wherein SL and CL1 are polypropylene-based layers. Furthermore, the present invention refers to a process for manufacturing the coated article and to its use. Another aspect of the present invention relates to a process for recycling the coated article to obtain a recycled polypropylene and to the use of said recycled polypropylene.

The present invention relates to a polypropylene-based coated article, a process for manufacturing the coated article and to its use.

One common coating method is extrusion coating. In general, extrusion coating of substrates such as paper, paperboard, fabrics and metal foils with a thin layer of plastic is practiced on a large scale. The coating composition is extruded in a first step whereby the flux of molten polymeric material passes through a flat die to obtain a film having a thickness of a few microns. In the second step, i.e. the coating step, the film is laid on a support and passed on a cooling cylinder. Upon cooling, the polymer adheres to its support. High speed extrusion coating asks for relative high melt flow rates MFR₂ of 10 g/10 min or higher.

Polypropylene compositions suitable for coating, especially for extrusion coating are already known in the art.

EP 2 492 293 A1 refers to a polypropylene composition suitable for extrusion coating or extrusion foaming for a broad variety of substrates having high melt strength and drawability, excellent processability, low gel content, and being capable of withstanding high temperatures, a process for the provision of such polypropylene compositions and extrusion coated or extrusion foamed articles.

EP 3 018 154 A1 relates to a propylene homopolymer or copolymer having a comonomer in the copolymer selected from ethylene, C4 to C20-alpha olefin, said propylene homopolymer or copolymer being free of phthalic compound. It further relates to a longchain branched propylene homopolymer or copolymer (b-PP) having a comonomer in the copolymer selected from ethylene, C4 to C20-alpha olefins, said long-chain branched propylene homopolymer or copolymer (b-PP) being free of phthalic compound.

WO 2012/109449 A1 refers to a process of extruding a blend of an irradiated first propylene polymer and a non-irradiated second propylene polymer, where the first propylene polymer comprises a non-phenolic stabilizer. The irradiation of the first propylene polymer extrudate is conducted in a reduced oxygen environment, and the irradiated first propylene polymer and the non-irradiated second propylene polymer are blended at a temperature below their respective melting points. The blend has a viscosity retention of 20 to 35%.

Polypropylene coated articles are widely used in packaging, the key requirements are sterilizabilty and sealing properties. However, there is still the need for coated articles having a very good sealing behaviour.

Therefore, it was one objective of the present invention to provide a new type of polypropylene with improved sealing properties, like a higher hot tack force (=HTF) and a lower hot tack temperature. Another problem is the recycling of coated articles after their first use. It is much more challenging to recycle coated articles made of different materials, e.g. paper and plastics than to recycle mono-material solutions. On the other hand, the use of different materials is necessary to obtain acceptable properties, like sealing properties and mechanical properties. Therefore, another objective of the present invention is the provision of a polypropylene based mono-material solution, which shows a good sealing behaviour.

These objects have been solved by the coated article according to claim 1 comprising at least a substrate layer (SL), a first coating layer (CL1) and a second coating layer (CL2), wherein CL2 comprises a polypropylene composition comprising
(A) a polypropylene homopolymer having
   a melt flow rate MFR₂ (230° C./2.16 kg) measured according to ISO 1133 in the range from 10 to 40 g/10 min;
   a melting temperature Tₘ as determined by DSC according to ISO 11357 in the range from 149 to 162° C.; and
   a molecular weight distribution MWD in the range from 2.4 to 4.5 as determined by GPC; and/or
(B) an ethylene propylene random copolymer having
   a melt flow rate MFR₂ (230° C./2.16kg) measured according to ISO 1133 in the range from 4 to 40 g/10 min;
   a melting temperature Tₘ as determined by DSC according to ISO 11357 in the range from 115 to 145° C.; and
   a number of 2,1 and 3,1 regio defects in the range from 0.01 to 1.2 mol-% as measured by ¹³C NMR; and wherein
SL and CL1 are polypropylene-based layers.

Advantageous embodiments of the coated article in accordance with the present invention are specified in the dependent claims 2 to 11. Claim 12 of the present invention relates to a process for manufacturing the coated article and claim 13 refers to the use of the coated article as packaging material. Claim 14 according to the present invention refers to a process for recycling the coated article to obtain a recycled polypropylene and claim 15 refers to the use of said recycled polypropylene.

### DEFINITIONS

### Regio Defects

The region defects of propylene polymers can be of three different types, namely 2,1-erythro (2,Ie), 2,1-threo (2,It) and 3,1 defects. A detailed description of the structure and mechanism of formation of regio defects in polypropylene can be found in Chemical Reviews 2000, 100(4), pages 1316 to 1327. These defects are measured using ¹³C NMR as described in more detail below.

The term “2,1 regio defects” as used in the present invention defines the sum of 2,1-erythro regio-defects and 2,1-threo regio defects. Propylene random copolymers or polypropylene homopolymers having a number of regio defects as required in the propylene composition of the invention are usually and preferably prepared in the presence of a single-site catalyst.

The catalyst influences in particular the microstructure of the polymer. Accordingly, polypropylenes prepared by using a metallocene catalyst provide a different microstructure compared to those prepared by using Ziegler-Natta (ZN) catalysts. The most significant difference is the presence of regio-defects in metallocene-made polypropylenes which is not the case for polypropylenes made by Ziegler-Natta (ZN) catalysts.

Where the term “comprising” is used in the present description and claims, it does not exclude other non-specified elements of major or minor functional importance. For the purposes of the present invention, the term “consisting of” is considered to be a preferred embodiment of the term “comprising of”. If hereinafter a group is defined to comprise at least a certain number of embodiments, this is also to be understood to disclose a group, which preferably consists only of these embodiments.

Whenever the terms “including” or “having” are used, these terms are meant to be equivalent to “comprising” as defined above.

Where an indefinite or definite article is used when referring to a singular noun, e.g. “a”, “an” or “the”, this includes a plural of that noun unless something else is specifically stated.

### Polypropylene Homopolymer (A)

The second coating layer (CL2) of the coated article according to the present invention may comprise a polypropylene composition comprising a polypropylene homopolymer (A) having a melt flow rate MFR₂ (230° C./2.16 kg) measured according to ISO 1133 in the range from 10 to 40 g/10 min; a melting temperature Tₘ as determined by DSC according to ISO 11357 in the range from 149 to 162° C.; and a molecular weight distribution MWD in the range from 2.4 to 4.5 as determined by GPC.

Preferred embodiments of polypropylene homopolymer (A) will be discussed in the following.

According to one preferred embodiment in accordance with the present invention polypropylene homopolymer (A) has one or more of the following characteristics:
a number of 2,1 and 3,1 regio defects in the range from 0.01 to 1.2 mol-%, preferably from 0.4 to 0.85 mol-%, and more preferably from to 0.45 to 0.8 mol-% as measured by ¹³C NMR;
has been produced in the presence of a single-site catalyst, preferably in the presence of a metallocene catalyst;
a melt flow rate MFR₂ (230° C./2.16 kg) measured according to ISO 1133 in the range from 15 to 37 g/10 min, preferably 20 to 35 g/10 min and a melting temperature Tₘ as determined by DSC according to ISO 11357 in the range from 150 to 158° C., preferably 153 to 157° C.;
a MWD in the range from 2.5 to 4.5 as determined by GPC;
a xylene cold soluble (XCS) fraction as determined according to ISO 16152 in the range from 0.05 to below 5 wt.-% and preferably 0.1 to 4 wt.-%.

In a further preferred embodiment in accordance with the present invention the polypropylene homopolymer (A) comprises two polymer fractions (PPH-1) and (PPH-2) wherein the split between fractions (PPH-1) and (PPH-2) is in the range from 30:70 to 70:30, preferably 45:55 to 65:35, and more preferably 55:45 to 60:40. Furthermore, it is preferred that (PPH-1) has a melt flow rate MFR₂ (230° C./2.16 kg) measured according to ISO 1133 in the range from 10 to 50 g/10 min, more preferably from 15 to 40 g/10 min and most preferably from 20 to 35 g/10 min, and/or that (PPH-2) has a melt flow rate MFR₂ (230° C./2.16 kg) measured according to ISO 1133 in the range of from 10 to 50 g/10 min, more preferably 15 to 40 g/10 min and most preferably 20 to 35 g/10 min.

Another preferred embodiment in accordance with the present invention stipulates that polypropylene homopolymer (A) has the advantage of having only a low amount of hexane extractables. Thus, it is preferred that the polypropylene homopolymer (A) has a hexane extractables content as measured according to the FDA test of less than 2.0 wt.-%, more preferably of less than 1.5 wt.-%.

In a further preferred embodiment of the present invention the polypropylene homopolymer (A) has a crystallization temperature Tc as determined by DSC according to ISO 11357 in the range of 100 to 130° C., more preferably in the range of 105° C. to 125° C., like in the range of 110° C. to 120° C.

Another preferred embodiment of the present invention stipules that the polypropylene homopolymer (A) is produced in the presence of a metallocene catalyst, which is preferably a metallocene catalyst comprising a complex in any one of the embodiments as described in WO 2013/007650 A1, WO 2015/158790 A2 and WO 2018/122134 A1. In another preferred embodiment of the present invention a cocatalyst system comprising a boron containing cocatalyst, e.g. a borate cocatalyst and an aluminoxane cocatalyst is used.

The polypropylene homopolymer (A) in any of its embodiments comprising two fractions (PPH-1) and (PPH-2) is preferably produced in a process comprising the following steps:
a) polymerizing in a first reactor (R1) propylene obtaining polymer fraction (PPH-1),
b) transferring said polymer fraction (PPH-1) and unreacted monomers of the first reactor in a second reactor (R2),
c) feeding to said second reactor (R2) propylene,
d) polymerizing in said second reactor (R2) and in the presence of said polymer fraction (PPH-1) propylene to obtain polymer fraction (PPH-2) in an intimate mixture with (PPH-1) and hence the final polypropylene, whereby preferably the polymerization takes place in the presence of a metallocene catalyst system in any one of the embodiments as described herein.

Further aspects of the polypropylene homopolymer (A) and methods for manufacturing said homopolymer are inter alia described in an at the time of filing the present application unpublished European patent application (application number: 20176798.5, filed on May 27, 2020) of the same applicant as the present application.

### Ethylene Propylene Random Copolymer (B)

The second coating layer (CL2) of the coated article according to the present invention may comprise a polypropylene composition comprising an ethylene propylene random copolymer (B) having a melt flow rate MFR₂ (230° C./2.16 kg) measured according to ISO 1133 in the range from 4 to 40 g/10 min; a melting temperature Tₘ as determined by DSC according to ISO 11357 in the range from 115 to 145 ° C.; and a number of 2,1 and 3,1 regio defects in the range from 0.01 to 1.2 mol-% as measured by ¹³C NMR.

Preferred embodiments of the ethylene propylene random copolymer (B) will be discussed in the following.

One preferred embodiment of the present invention stipulates that the ethylene propylene random copolymer (B) has one or more of the following characteristics:
has been produced in the presence of a single-site catalyst;
molecular weight distribution MWD as determined by GPC in the range from 2.4 to 5.5, preferably 2.5 to 4.5;
a hexane extractables content as measured according to the FDA test of less than 2.0 wt.-%, preferably less than 1.5 wt.-%, more preferably 0.1 to 1.5 wt.-%;
a melt flow rate MFR₂ (230° C./2.16 kg) measured according to ISO 1133 in the range of 17 to 35 g/10 min or 4 to 7 g/10 min, and a melting temperature Tₘ as determined by DSC according to ISO 11357 of 120 to 140° C.;
a number of 2,1 and 3,1 regio defects in the range from 0.1 to 1.0 mol-% as measured by ¹³C NMR.

According to another preferred embodiment in accordance with the present invention the ethylene propylene random copolymer (B) is an ethylene propylene random copolymer having an ethylene content in the range from 2.0 to 5.5 wt.-%, or in the range of 2.2 to 4.5 wt.-% based on the weight of the ethylene propylene random copolymer.

In still a further preferred embodiment of the present invention the ethylene propylene random copolymer (B) has a crystallization temperature T_{c} as determined by DSC according to ISO 11357 in the range from 75 to 110° C., preferably 80 to 105° C.

Another preferred embedment of the present invention stipulates that the ethylene propylene random copolymer (B) has a xylene cold soluble (XCS) fraction as determined according to ISO 16152 of from 0.1 to below 15 wt.-%; preferably from 0.5 to 5 wt.-% based on the weight of the propylene random copolymer (B).

According to a further preferred embodiment of the present invention the ethylenepropylene random copolymer (B) comprises, or consists of, two polymer fractions (RACO-1) and (RACO-2) and the split between fractions (RACO-1) and (RACO-2) is preferably from 30:70 to 70:30. Optionally, a small fraction of prepolymer, usually below 5 wt.-%, may also be present in the random propylene copolymer (B).

Still another preferred embodiment in accordance with the present invention stipulates that preferably (RACO-1) has an ethylene content in the range of 1.5 to 5.5 wt.-%, more preferably of 2.0 to 5.0 wt.-% and most preferably of 2.5 to 4.0 wt.-%, and/or preferably (RACO-2) has an ethylene content in the range of 2.0 to 6.0 wt.-%, more preferably of 2.5 to 5.5 wt.-% and most preferably of 3.0 to 5.0 wt.-%. The ethylene content of fraction (RACO-1) is preferably lower than the ethylene content of fraction (RACO-2). Furthermore, it is preferred that (RACO-1) has a melt flow rate MFR₂ (230° C./2.16 kg) measured according to ISO 1133 in the range of from 3.0 to 20.0 g/10 min, more preferably 5.0 to 17.0 g/10 min or 3.0 to 7.0 g/10 min and most preferably 7.0 to 15.0 g/10 min or 4.0 to 6.0 g/10 min, and/or that (RACO-2) has a melt flow rate MFR2 (230° C./2.16 kg) measured according to ISO 1133 in the range of from 5.0 to 50.0 g/10 min, more preferably 10 to 40 g/10 min and most preferably 15 to 30 g/10 min.

Another preferred embodiment of the present invention stipules that the ethylene propylene random copolymer (B) is produced in the presence of a metallocene catalyst, which is preferably a metallocene catalyst comprising a complex in any one of the embodiments as described in WO 2013/007650 A1, WO 2015/158790 A2 and WO 2018/122134 A1. In another preferred embodiment of the present invention a cocatalyst system comprising a boron containing cocatalyst, e.g. a borate cocatalyst and an aluminoxane cocatalyst is used.

The ethylene propylene random copolymer (B) in any of its embodiments comprising two fractions (RACO-1) and (RACO-2) is preferably produced in a process comprising the following steps:
a) polymerizing in a first reactor (R1) propylene and ethylene comonomer obtaining polymer fraction (RACO-1),
b) transferring said polymer fraction (RACO-1) and unreacted comonomers of the first reactor in a second reactor (R2),
c) feeding to said second reactor (R2) propylene and ethylene comonomer,
d) polymerizing in said second reactor (R2) and in the presence of said polymer fraction (RACO-1) propylene and comonomer to obtain polymer fraction (RACO-2) in an intimate mixture with (RACO-1) and hence the final ethylene propylene random copolymer,whereby preferably the polymerization takes place in the presence of a metallocene catalyst system in any one of the embodiments as described herein.

Further aspects of the ethylene propylene random copolymer (B), methods for manufacturing said copolymer are inter alia described in an at the time of filing the present application unpublished European patent application (application number: 20176795.5, filed on May 27, 2020) of the same applicant as the present application.

### Polypropylene Composition

The second coating layer (CL2) of the coated article according to the present invention CL2 comprises a polypropylene composition comprising polypropylene homopolymer (A) or ethylene propylene random copolymer (B).

The polypropylene composition may comprise one or more usual additives, preferably in a total amount of from 0.01 up to 5.0 wt.-%, more preferably from 0.05 to 3.0 wt.-% based on the total weight of the polypropylene composition, selected from the group consisting of slip agents, anti-block agents, UV stabilizers, antistatic agents, alpha-nucleating agents, antioxidants and mixtures thereof. Preferably at least an antioxidant is added to the composition of the invention.

### Coated Article

The coated article in accordance with the present invention comprises at least a substrate layer (SL), a first coating layer (CL1) and a second coating layer (CL2).

According to a preferred embodiment in accordance with the present invention the polypropylene-based layers SL and CL1 contain more than 90 wt.-% polypropylene, preferably from 95 to 100 wt.-% polypropylene, more preferably 99 to 100 wt.-% polypropylene each based on the total weight of the layer and most preferably consist of polypropylene.

Still another preferred embodiment in accordance with the present invention stipulates that the polypropylene in layer SL is a biaxially oriented polypropylene and/or the polypropylene in layer CL1 is selected from the group consisting of copolymers and homopolymers of polypropylene and mixtures thereof, preferably the homopolymer (A) or the random copolymer (B), more preferably a heterophasic copolymer being a specific type of random copolymer.

In case the polypropylene in layer CL1 is a heterophasic copolymer said compound preferably has one more of the following properties:
a density in the range from 890 to 900 kg/m3;
a MFR₂ (230° C., 2.16 kg) in the range from 10 to 16 g/10 min);
a melting temperature in the range from 160 to 164° C.;
a crystallization temperature in the range from 120 to 128° C.;
a Vicat softening temperature A (10 N, determined according to ISO 306) in the range from 140 to 155° C.

According to a further preferred embodiment in accordance with the present invention the coated article comprises less than 10 wt.-%, preferably less than 5 wt.-%, more preferably less than 1 wt.-% materials different from polypropylene, still more preferably the coated article consists of polypropylene.

To determine other materials different from polypropylene, any known methods are suitable, for example NMR, IR, etc. One of the preferred methods is Confocal Raman Microscopy, which provide the higher spatial resolution down to micro meter scale. Raman spectroscopy is sensitive to both chemical and physical properties, generating a molecular fingerprint that is well suited to material identification (see for example Paulette Guillory at al., Materials Today, 2009, 12, 38 to 39).

In a further preferred embodiment of the present invention the coated article is not comprising any layers which are not polypropylene-based, preferably the coated article consists of layers SL, CL1 and CL2, this means the coated article is a perfect mono-material solution consisting of polypropylene.

According to still another preferred embodiment of the present invention CL2 comprises and preferably consists of a polypropylene homopolymer (A) and the sealing initiation temperature of the article is in the range from 105 to 118° C., preferably 110 to 116° C. and more preferably 113 to 115° C.

In another preferred embodiment of the present invention CL2 comprises and preferably consists of an ethylene propylene random copolymer (B) and the sealing initiation temperature of the article is in the range from 60 to 100° C., preferably from 78 to 87° C., more preferably from 80 to 86° C. and still more preferably from 81 to 85° C.

Still another preferred embodiment of the present invention stipulates that the total thickness of the coated article is in the range from 10 to 200 μm, preferably from 12 to 170 μm and more preferably in the range from 15 to 100 μm.

In another preferred embodiment of the present invention the thickness of the layer SL is in the range from 5 to 40 μm, preferably from 10 to 30 μm and more preferably in the range from 15 to 25 μm.

According to still another preferred embodiment of the present invention the coating weight of layer CL1 is in the range from 1 to 20 g/m², preferably from 3 to 18 g/m², more preferably from 5 to 15 g/m² and still more preferably from 7 to 12 g/m².

Still another preferred embodiment of the present invention stipulates that the coating weight of layer CL2 is in the range from 1 to 20 g/m², preferably from 3 to 18 g/m², more preferably from 5 to 15 g/m² and still more preferably from 7 to 12 g/m².

According to another preferred embodiment in accordance with the present invention the coated article is an extrusion coated article.

### Process

The present invention also relates to a process for manufacturing the coated article according to the present invention and said process comprises an extrusion coating step.

The extrusion coating process may be carried out using conventional extrusion coating techniques. Hence, the composition according to the present invention may be fed, typically in the form of pellets, to an extruding device. From the extruder the polymer melt is passed preferably through a flat die to the substrate to be coated. The coated substrate is cooled on a chill roll, after which it is passed to edge trimmers and wound up.

The die width typically depends on the size of the extruder used. Thus with 90 mm extruders the width may suitably be within the range of 600 to 1,200 mm, with 115 mm extruders from 900 to 2,500 mm, with 150 mm extruders from 1,000 to 4,000 mm and with 200 mm extruders from 3,000 to 5,000 mm. The line speed (draw-down speed) is preferably 75 m/min or more, more preferably at least 100 m/min. In most commercially operating machines the line speed is preferably more than 300 m/min or more than 500 m/min. Modern machines are designed to operate at lines speeds of up to 1,000 m/min, for instance 300 to 800 m/min.

The temperature of the polymer melt is typically between 240 and 330° C. The polypropylene composition of the invention can be extruded onto the substrate as a monolayer coating or as an outer layer in a co-extrusion process. In a multilayer extrusion coating, a polymer layer structure as defined above and optionally the other polymeric layers may be co-extruded. It is possible to further perform ozone and/or corona treatment in a known way, if desired or necessary.

### Use

The present invention also refers to the use of the coated article as packaging material, preferably as a temperature resistant packaging material for food and/or medical products.

Preferred packaging applications are liquid packaging for milk, juice, wine or other liquids. The coated article may be use used for flexible packaging applications preferably for snacks, confectionary, meat, cheese or for rigid packaging application or in sterilizable food packaging.

### Recycling

Another aspect of the present invention refers to a process for recycling the coated article to obtain a recycled polypropylene and to the use of said recycled polypropylene for manufacturing moulded articles and films.

The invention will now be described with reference to the following non-limiting examples.

### EXPERIMENTAL PART

### A. Measuring Methods

The following definitions of terms and determination methods apply for the above general description of the invention as well as to the below examples unless otherwise defined.

### Melt Flow Rate

The melt flow rate (MFR) was determined according to ISO 1133—Determination of the melt mass-flow rate (MFR) and melt volume-flow rate (MVR) of thermoplastics—Part 1: Standard method and is indicated in g/10 min. The MFR is an indication of the flowability, and hence the processability, of the polymer. The higher the melt flow rate, the lower the viscosity of the polymer. The MFR₂ of polypropylene is determined at a temperature of 230° C. and a load of 2.16 kg.

### Comonomer Content of the Second Polymer Fraction (RACO-2)

The comonomer content of the second polymer faction (RACO-2) is calculated according to formula (I).

$$\frac{C ( A ) - w ( A 1 ) \times C ( A 1 )}{w ( A 2 )} = C ( A 2 ) \qquad ( I )$$

wherein
w(A-1) is the weight fraction [in wt.-%] of the first polymer fraction (RACO-1),
w(A-2) is the weight fraction [in wt.-%] of second polymer fraction (RACO-2),
C(A-1) is the comonomer content [in wt.-%] of the first polymer fraction (RACO-1),
C(A) is the comonomer content [in wt.-%] of the C 2 C 3 random copolymer (RACO),
C(A-2) is the calculated comonomer content [wt.-%] of the second polymer fraction (RACO-2).

### Calculation of Melt Flow Rate MFR₂ of the Polymer Fraction (RACO-2)

The MFR of the second polymer faction (RACO-2) is calculated according to formula (II).

$$MFR ( A 2 ) = 10 [ \frac{log ( MFR ( A ) ) - w ( A 1 ) \times log ( MFR ( A 1 ) )}{w ( A 2 )} ] \qquad ( II )$$

wherein
w(A1) is the weight fraction [in wt.-%] of the polymer fraction RACO-1,
w(A2) is the weight fraction [in wt.-%] of the polymer fraction RACO-2,
MFR(A1) is the melt flow rate MFR₂ (230° C.) [g/10 min] of the polymer fraction RACO-1,
MFR(A) is the melt flow rate MFR₂ (230° C.) [g/10 min] of the entire random propylene copolymer (RACO),
MFR(A2) is the calculated melt flow rate MFR₂ (230° C.) [g/10 min] of the polymer fraction RACO-2.

### Quantification of Microstructure by NMR Spectroscopy (Comonomer Content & Regiodefects)

Quantitative nuclear-magnetic resonance (NMR) spectroscopy was further used to quantify the comonomer content and comonomer sequence distribution of the polymers. Quantitative ¹³C{¹H} spectra were recorded in the solution-state using a Bruker Advance III 400 NMR spectrometer operating at 400.15 and 100.62 MHz for ¹H and ¹³C respectively. All spectra were recorded using a ¹³C optimized 10 mm extended temperature probe head at 125° C. using nitrogen gas for all pneumatics. Approximately 200 mg of material was dissolved in 3 ml of 1,2-tetrachloroethane-d₂ (TCE-d₂) along with chromium-(III)-acetylacetonate (Cr(acac)₃) resulting in a 65 mM solution of relaxation agent in solvent (Singh, G., Kothari, A., Gupta, V., Polymer Testing 28 5 (2009), 475). To ensure a homogenous solution, after initial sample preparation in a heat block, the NMR tube was further heated in a rotatary oven for at least 1 hour. Upon insertion into the magnet the tube was spun at 10 Hz. This setup was chosen primarily for the high resolution and quantitatively needed for accurate ethylene content quantification. Standard single-pulse excitation was employed without NOE, using an optimized tip angle, 1 s recycle delay and a bi-level WALTZ16 decoupling scheme (Zhou, Z., Kuemmerle, R., Qiu, X., Redwine, D., Cong, R., Taha, A., Baugh, D. Winniford, B., J. Mag. Reson. 187 (2007) 225; Busico, V., Carbonniere, P., Cipullo, R., Pellecchia, R., Severn, J., Talarico, G., Macromol. Rapid Commun. 2007, 28, 1128). A total of 6144 (6 k) transients were acquired per spectra. Quantitative ¹³C{¹H} NMR spectra were processed, integrated and relevant quantitative properties determined from the integrals using proprietary computer programs. All chemical shifts were indirectly referenced to the central methylene group of the ethylene block (EEE) at 30.00 ppm using the chemical shift of the solvent. This approach allowed comparable referencing even when this structural unit was not present. Characteristic signals corresponding to the incorporation of ethylene were observed Cheng, H. N., Macromolecules 17 (1984), 1950).

With characteristic signals corresponding to 2,1 erythro regio defects observed (as described in L. Resconi, L. Cavallo, A. Fait, F. Piemontesi, Chem. Rev. 2000, 100 (4), 1253, in Cheng, H. N., Macromolecules 1984, 17, 1950, and in W-J. Wang and S. Zhu, Macromolecules 2000, 33 1157) the correction for the influence of the regio defects on determined properties was required. Characteristic signals corresponding to other types of regio defects were not observed.

The comonomer fraction was quantified using the method of Wang et. al. (Wang, W-J., Zhu, S., Macromolecules 33 (2000), 1157) through integration of multiple signals across the whole spectral region in the ¹³C{¹H} spectra. This method was chosen for its robust nature and ability to account for the presence of regio-defects when needed. Integral regions were slightly adjusted to increase applicability across the whole range of encountered comonomer contents.

For systems where only isolated ethylene in PPEPP sequences was observed the method of Wang et. al. was modified to reduce the influence of non-zero integrals of sites that are known to not be present. This approach reduced the overestimation of ethylene content for such systems and was achieved by reduction of the number of sites used to determine the absolute ethylene content to:

E=0.5(Sββ+Sβγ+Sβδ+0.5(Sαβ+Sαγ))

Through the use of this set of sites the corresponding integral equation becomes:

E=0.5(I_{H}+I_{G}+0.5(I_{C}+I_{D}))

using the same notation used in the article of Wang et. al. (Wang, W-J., Zhu, S., Macromolecules 33 (2000), 1157). Equations used for absolute propylene content were not modified.

The mole percent comonomer incorporation was calculated from the mole fraction:

E[mol %]=100*fE

The weight percent comonomer incorporation was calculated from the mole fraction: E[wt %]=100*(fE*28.06)/((fE*28.06)+((1−fE)*42.08))

The comonomer sequence distribution at the triad level was determined using the analysis method of Kakugo et al. (Kakugo, M., Naito, Y., Mizunuma, K., Miyatake, T. Macromolecules 15 (1982) 1150). This method was chosen for its robust nature and integration regions slightly adjusted to increase applicability to a wider range of comonomer contents.

### Xylene Solubles (XCS, wt.-%)

The xylene soluble (XCS) fraction as defined and described in the present invention was determined in line with ISO 16152 as follows: 2.0 g of the polymer were dissolved in 250 ml p-xylene at 135° C. under agitation. After 30 minutes, the solution was allowed to cool for 15 minutes at ambient temperature and then allowed to settle for 30 minutes at 25+/−0.5° C. The solution was filtered with filter paper into two 100 ml flasks. The solution from the first 100 ml vessel was evaporated in nitrogen flow and the residue dried under vacuum at 90° C. until constant weight is reached. The xylene soluble fraction (percent) can then be determined as follows:

XCS %=(100*m*V0)/(m0*v)
m0=initial polymer amount (g);
m=weight of residue (g);
V0=initial volume (ml);
v=volume of analysed sample (ml).

### DSC Analysis, Melting (Tm) and Crystallization Temperature (Tc)

Data were measured with a TA Instrument Q2000 differential scanning calorimetry (DSC) on 5 to 7 mg samples. DSC was run according to ISO 11357/part 3/method C2 in a heat/cool /heat cycle with a scan rate of 10° C./min in the temperature range of −30 to +225° C. Crystallization temperature (T_{c}) and crystallization enthalpy (H_{c}) were determined from the cooling step, while melting temperature (Tₘ ) and melting enthalpy (Hₘ) are determined from the second heating step.

### Flexural Modulus

Flexural modulus was determined according to ISO 178 on 80×10×4 mm³ test bars injection moulded in line with EN ISO 1873-2.

### Hexane Extractables

The hexane extractable fraction is determined according to FDA method (federal registration, title 21, Chapter 1, part 177, section 1520, s. Annex B) on cast films of 100 μm thickness produced on a monolayer cast film line with a melt temperature of 220° C. and a chill roll temperature of 40° C. The extraction was performed at a temperature of 50° C. and an extraction time of 30 min.

### Molecular Weight Properties

Number average molecular weight (Mn), weight average molecular weight (Mw) and polydispersity (Mw/Mn) were determined by Gel Permeation Chromatography (GPC) according to the following method.

The weight average molecular weight Mw and the polydispersity (Mw/Mn), wherein Mn is the number average molecular weight and Mw is the weight average molecular weight) were measured by a method based on ISO 16014-1 :2003 and ISO 16014-4:2003. A Waters Alliance GPCV 2000 instrument, equipped with refractive index detector and online viscosimeter was used with 3 x TSK-gel columns (GMHXL-HT) from TosoHaas and 1,2,4- trichlorobenzene (TCB, stabilized with 200 mg/L 2,6-Di tert butyl-4-methyl-phenol) as solvent at 145° C. and at a constant flow rate of 1 mL/min. 216.5 μl of sample solution were injected per analysis. The column set was calibrated using relative calibration with 19 narrow MWD polystyrene (PS) standards in the range of 0.5 kg/mol to 11′500 kg/mol and a set of well characterized broad polypropylene standards. All samples were prepared by dissolving 5 to 10 mg of polymer in 10 mL (at 160° C.) of stabilized TCB (same as mobile phase) and keeping for 3 hours with continuous shaking prior sampling in into the GPC instrument.

### Sealing Behavior

The sealing behavior of the coatings was determined by measuring the hot tack force as follows. The maximum hot-tack force, i.e. the maximum of a force/temperature diagram was determined and reported. Hot tack measurements were made with J&B hot tack tester following the method ASTM F 1921. The standard requires that the samples have to be cut into 15 mm slices in width. The samples are placed into the hot tack testing machine in vertical direction both ends attached to a mechanical lock. Then the tester seals and pulls out the hot seal and the resisting force were measured.

The sealing parameters were:

| | | |
|---|---|---|
| Seal Pressure: | 1.5 | N/mm² |
| Seal Time: | 0.5 | sec |
| Cool time: | 0.20 | sec |
| Peel Speed: | 200 | mm/sec |
| Width: | 15.0 | mm |

### B. Materials Used

Kraft paper is a UG kraft paper (coating weight: 70 g/m²) commercially available from Billerud-Korsnas.

BOPP is a coextruded bi-oriented polypropylene film having a thickness of 20 mm, commercially available under the tradename RINCEL® MXM by CASFIL®.

WG341C is a polypropylene copolymer (Density=910 kg/m³ determined according to ISO 1183, Melt Flow Rate (230° C./2.16 kg)=25 g/10 min determined according to ISO 1133) commercially available from Borealis AG (Austria)

DaployTM WF420HMS is a structurally isomeric modified propylene homopolymer (Density=900 kg/m³ determined according to ISO 1183, Melt Flow Rate (230° C./2.16 kg)=26 g/10 min determined according to ISO 1133) commercially available from Borealis AG (Austria)

DaployTM SF313HMS is a structurally isomeric modified propylene homopolymer (Density=900 kg/m³ determined according to ISO 1183, Melt Flow Rate (230° C./2.16 kg)=15 g/10 min determined according to ISO 1133) commercially available from Borealis AG (Austria)

Polypropylene (PPH, homopolypropylene) was prepared as follows.

### Catalyst System

Metallocene (MC1) (rac-anti-dimethylsilandiyl(2-methyl-4-phenyl-5-methoxy-6-tert-butyl-indenyl) (2-methyl-4-(4-tert-butylphenyl)indenyl)zirconium dichloride)

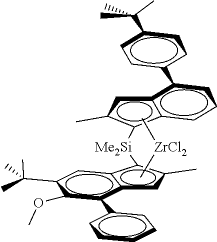

was synthesized according to the procedure as described in WO 2013/007650, E2. A MAO-silica support was prepared as follows.

A steel reactor equipped with a mechanical stirrer and a filter net was flushed with nitrogen and the reactor temperature was set to 20° C. Next silica grade DM-L-303 from AGC Si-Tech Co, pre-calcined at 600° C. (7.4 kg) was added from a feeding drum followed by careful pressuring and depressurising with nitrogen using manual valves. Then toluene (32 kg) was added. The mixture was stirred for 15 minutes. Next 30 wt.-% solution of MAO in toluene (17.5 kg) from Lanxess was added via feed line on the top of the reactor within 70 min. The reaction mixture was then heated up to 90° C. and stirred at 90° C. for additional two hours. The slurry was allowed to settle and the mother liquor was filtered off. The MAO treated support was washed twice with toluene (32 kg) at 90° C., following by settling and filtration. The reactor was cooled off to 60° C. and the solid was washed with heptane (32.2 kg). Finally MAO treated SiO₂ was dried at 60° under nitrogen flow for 2 hours and then for 5 hours under vacuum (−0.5 barg) with stirring. MAO treated support was collected as a free-flowing white powder found to contain 12.6 wt.-% Al.

The final catalyst system was prepared as follows: 30 wt.-% MAO in toluene (2.2 kg) was added into a steel nitrogen blanked reactor via a burette at 20° C. Toluene (7 kg) was then added under stirring. Metallocene MC1 (286 g) was added from a metal cylinder followed by flushing with 1 kg toluene. The mixture was stirred for 60 minutes at 20° C. Trityl tetrakis(pentafluorophenyl) borate (336 g) was then added from a metal cylinder followed by a flush with 1 kg of toluene. The mixture was stirred for 1 h at room temperature. The resulting solution was added to a stirred cake of MAO-silica support prepared as described above over 1 h. The cake was allowed to stay for 12 hours, followed by drying under N2 flow at 60° C. for 2 h and additionally for 5 h under vacuum (−0.5 barg) under stirring. The dried catalyst was sampled in the form of pink free flowing powder containing 13.9 wt.-% Al and 0.26 wt.-% Zr.

The polymerization for preparing the inventive polymer of PPH was performed in a Borstar pilot plant with a 2-reactor set-up (loop—gas phase reactor (GPR 1)) and a pre-polymerizer, using the catalyst system as described above.

In Table 1, the polymerization conditions for PPH and the final properties of the resin are given.

TABLE 1
Polymerization conditions for PPH and final properties.

| | Unit | PPH |
|---|---|---|
| Prepolymerizer | | |
| Temperature | ° C. | 25 |
| Pressure | kPa | 5153 |
| Loop | | |
| Temperature | ° C. | 75 |
| Pressure | kPa | 5400 |
| Feed H2/C3 | mol/kmol | 0.48 |
| Split | wt.-% | 62 |
| MFR₂ | g/10 min | 26.2 |
| GPR1 | | |
| Temperature | ° C. | 80 |
| H2/C3 | mol/kmol | 3 |
| Split | wt.-% | 38 |
| MFR₂ (final PP) | g/10 min | 27 |
| Final polymer | | |
| MFR | g/10 min | 27 |
| XCS | Wt.-% | 0.9 |
| Tm | ° C. | 153 |
| Tc | ° C. | 115 |
| 2, 1e | mol-% | 0.7 |
| 2, 1t | mol-% | 0 |
| 3, 1 | mol-% | 0 |
| FM | MPa | 1450 |
| MWD | n.m. | 3.4 |

n.m. = not measured

Polypropylene (PP1, propylene random copolymer) was prepared as follows.

### Catalyst System for PP1

Metallocene (MC1) (rac-anti-dimethylsilandiyl(2-methyl-4-phenyl-5-methoxy-6-tert-butyl-indenyl) (2-methyl-4-(4-tert-butylphenyl)indenyl)zirconium dichloride)

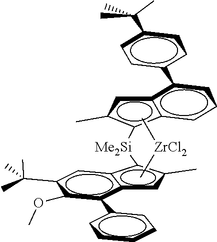

was synthesized according to the procedure as described in WO 2013/007650, E2. A MAO-silica support was prepared as follows: A steel reactor equipped with a mechanical stirrer and a filter net was flushed with nitrogen and the reactor temperature was set to 20° C. Next silica grade DM-L-303 from AGC Si-Tech Co, pre-calcined at 600° C. (7.4 kg) was added from a feeding drum followed by careful pressuring and depressurising with nitrogen using manual valves. Then toluene (32 kg) was added. The mixture was stirred for 15 minutes. Next 30 wt.-% solution of MAO in toluene (17.5 kg) from Lanxess was added via feed line on the top of the reactor within 70 minutes. The reaction mixture was then heated up to 90° C. and stirred at 90° C. for additional two hours. The slurry was allowed to settle and the mother liquor was filtered off.

The MAO treated support was washed twice with toluene (32 kg) at 90° C., following by settling and filtration. The reactor was cooled off to 60° C. and the solid was washed with heptane (32.2 kg). Finally MAO treated SiO 2 was dried at 60° C. under nitrogen flow for 2 hours and then for 5 hours under vacuum (−0.5 barg) with stirring. MAO treated support was collected as a free-flowing white powder found to contain 12.6 wt.-% Al.

The final catalyst system was prepared as follows: 30 wt.-% MAO in toluene (2.2 kg) was added into a steel nitrogen blanked reactor via a burette at 20° C. Toluene (7 kg) was then added under stirring. Metallocene MC1 (286 g) was added from a metal cylinder followed by flushing with 1 kg toluene. The mixture was stirred for 60 minutes at 20° C. Trityl tetrakis(pentafluorophenyl) borate (336 g) was then added from a metal cylinder followed by a flush with 1 kg of toluene. The mixture was stirred for 1 h at room temperature. The resulting solution was added to a stirred cake of MAO-silica support prepared as described above over 1 hour. The cake was allowed to stay for 12 hours, followed by drying under N₂ flow at 60° C. for 2 hours and additionally for 5 hours under vacuum (−0.5 barg) under stirring. Dried catalyst was sampled in the form of pink free flowing powder containing 13.9 wt.-% Al and 0.26 wt.-% Zr.

### Catalyst System for PP2

The catalyst used was Anti-dimethylsilanediyl[2-methyl-4,8-di(3,5-dimethylphenyl)-1,5,6,7-tetrahydro-s-indacen-1-yl][2-methyl-4-(3,5-dimethylphenyl)-5-methoxy-6-tert-butylinden-1-yl] zirconium dichloride as disclosed in WO 2020/239602 A1 as ICS3.

### Preparation of MAO-Silica Support

A steel reactor equipped with a mechanical stirrer and a filter net was flushed with nitrogen and the reactor temperature was set to 20° C. Next silica grade DM-L-303 from AGC Si-Tech Co, pre-calcined at 600° C. (5.0 kg) was added from a feeding drum followed by careful pressurising and depressurising with nitrogen using manual valves. Then toluene (22 kg) was added. The mixture was stirred for 15 minutes. Next 30 wt.-% solution of MAO in toluene (9.0 kg) from Lanxess was added via feed line on the top of the reactor within 70 min. The reaction mixture was then heated up to 90° C. and stirred at 90° C. for additional two hours. The slurry was allowed to settle and the mother liquor was filtered off. The catalyst was washed twice with toluene (22 kg) at 90° C., following by settling and filtration. The reactor was cooled off to 60° C. and the solid was washed with heptane (22.2 kg). Finally MAO treated SiO 2 was dried at 60° under nitrogen flow for 2 hours and then for 5 hours under vacuum (−0.5 barg) with stirring. MAO treated support was collected as a free-flowing white powder found to contain 12.2 wt.-% Al.

### Catalyst Preparation

30 wt.-% MAO in toluene (0.7 kg) was added into a steel nitrogen blanked reactor via a burette at 20° C. Toluene (5.4 kg) was then added under stirring. The catalyst as cited above (93 g) was added from a metal cylinder followed by flushing with 1 kg toluene. The mixture was stirred for 60 minutes at 20° C. Trityl tetrakis(pentafluorophenyl) borate (91 g) was then added from a metal cylinder followed by a flush with 1 kg of toluene. The mixture was stirred for 1 h at room temperature. The resulting solution was added to a stirred cake of MAO-silica support prepared as described above over 1 hour. The cake was allowed to stay for 12 hours, followed by drying under N₂ flow at 60° C. for 2 h and additionally for 5 h under vacuum (−0.5 barg) under stirring. Dried catalyst was sampled in the form of pink free flowing powder containing 13.9 wt.-% Al and 0.11 wt.-% Zr.

The polymerization for preparing the random copolymer of PP1 and PP2 was performed in a Borstar pilot plant with a 2-reactor set-up (loop—gas phase reactor (GPR 1)) and a pre-polymerizer, using the catalyst system as described above.

In Table 2, the polymerization conditions for PP1 and PP2 and the final properties of the resins are given.

TABLE 2
Polymerization conditions for PP1 and PP2 and final properties.

| | | PP1 | PP2 |
|---|---|---|---|
| Prepolymerizer | | | |
| Temperature | ° C. | 25 | 25 |
| Pressure | kPa | 5154 | 5008 |
| Loop | | | |
| Temperature | ° C. | 70 | 70 |
| Pressure | kPa | 5405 | 4875 |
| Feed H2/C3 | mol/kmol | 0.4 | 0.21 |
| Feed C2/C3 | mol/kmol | 42.07 | 40.87 |
| Split | wt.-% | 56 | 61 |
| C2 | wt.-% | 2.9 | 2.5 |
| MFR | g/10 min | 11 | 4.6 |
| GPR1 | | | |
| Temperature | ° C. | 80 | 80 |
| H2/C3 | mol/kmol | 8.4 | 3.3 |
| C2/C3 | mol/kmol | 177 | 132 |
| Split | wt.-% | 44 | 39 |
| C2 (total resin) | wt.-% | 3.8 | 3.1 |
| MFR₂ (total | g/10 min | 25 | 5.2 |
| resin | | | |
| Final polymers | | | |
| MFR | g/10 min | 25 | 5 |
| C2 | wt.-% | 3.8 | 3.1 |
| XCS | wt.-% | 2.7 | 1.2 |
| Tm | ° C. | 128 | 129 |
| Tc | ° C. | 91 | 94 |
| 2, 1e | mol % | 0.4 | 0.4 |
| 2, 1t | mol % | 0 | 0 |
| 3, 1e | mol % | 0 | 0 |
| FM | MPa | 778 | 759 |
| MWD | | 3.4 | 2.4 |
| C6 FDA | wt-. % | 1.1 | n.m. |

n.m. = not measured

The polymer powders (PPH, PP1 and PP2) were compounded in a co-rotating twin-screw extruder Coperion ZSK 70 at 220° C. with 0.2 wt.-% antiblock agent (synthetic silica; CAS-no. 7631-86-9); 0.1 wt.-% antioxidant (Irgafos 168FF); 0.1 wt.-% of a sterically hindered phenol (Irganox 1010FF); 0.02 wt.-% of Ca-stearate) and 0.02 wt.-% (each based on the total weight of the polymer) of a non-lubricating stearate (Synthetic hydrotalcite; CAS-no. 11097-59-9).

### C. Coated Articles

Using the compounded resins PPH, PP1 and PP2 as described above, coated articles as summarised in Table 3 were prepared by extrusion coating of the resins as follows.

Extrusion coating runs were made on Beloit co-extrusion coating line. It had Peter Cloeren's EBR die and a five layer feed block. The width of the line was 850 to 1′000 mm and the maximum possible line speed was 1′000 m/min. The line speed was maintained at 150 m/min.

In the coating line as described above a Kraft paper (Comparative Examples 1 and 2) or BOPP (Inventive Examples 1 to 3) were coated with a co-extruded structure, which was composed of two coating layers (Coating layer 1 and 2) both having a coating weight of 9 g/m 2 (total coating weight=18 g/m²).

The temperature of the polymer melt was set to 290° C. and the extruders' temperature profile was 200-240-290-290 ° C. The chill roll was matt and temperature of its surface was 15° C. Used die opening was 0.65 mm and nip distance was 180 mm. The melt film touched the substrate for the first time +10 mm from nip to substrate side. Pressure of the pressure roll was 3.0 kp/cm² . The line speed was 150 m/min.

TABLE 3
Composition and SIT of extrusion coated articles.

| | CE1 | IE1 | CE2 | IE2 | IE3 |
|---|---|---|---|---|---|
| Substrate layer | Kraft paper | BOPP | Kraft paper | BOPP | BOPP |
| (SL) | | | | | |
| Thickness [μm] | — | 20 | — | 20 | 20 |
| Coating weight | 70 | — | 70 | — | — |
| [g/m²] | | | | | |
| Coating layer 1 | WG341C | WG341C | WG341C | WF420HMS | SF313HMS |
| (CL1) | | | | | |
| Coating weight | 9 | 9 | 9 | 9 | 9 |
| CL1 [g/m²] | | | | | |
| Coating layer 2 | PPH | PPH | PP1 | PP1 | PP2 |
| (CL2) | | | | | |
| Coating weight | 9 | 9 | 9 | 9 | 9 |
| CL2 [g/m²] | | | | | |
| SIT [° C.] | 120 | 114 | 88 | 85 | 81 |

Sealing initiation temperature (SIT) values are obtained from hot tack measurement. In the present invention the lowest SIT is defined to be the temperature (° C.), where hot-tack strength is reaching 1 N, and highest sealing temperature (SET) is the temperature (° C.), where hot-tack strength is still at 1 N.

### D. Discussion of the Results

As can be gathered from above Table 3 the full polypropylene based articles according to the Inventive Examples 1 to 3 show significantly lower SIT values than the coated articles comprising a substrate layer made of kraft paper according to Comparative Examples 1 and 2. Furthermore, the coated articles according to the invention have the advantage that they are easy to recycle, since besides polypropylene no other materials are contained. Moreover, as can be seen from the data in Table 2, the PP1 as used in the coated article of IE2 has a very low amount of hexane extractables according to the FDA test (1.1 wt.-%) and is thus very well suited for any kind of food applications.

1. A coated article comprising at least a substrate layer (SL), a first coating layer (CL1) and a second coating layer (CL2), wherein CL2 comprises a polypropylene composition comprising
(A) a polypropylene homopolymer having
a melt flow rate MFR₂ (230° C./2.16 kg) measured according to ISO 1133 in the range from 10 to 40 g/10 min;
a melting temperature Tm as determined by DSC according to ISO 11357 in the range from 149 to 162° C.; and
a molecular weight distribution MWD in the range from 2.4 to 4.5 as determined by GPC; and/or
(B) an ethylene propylene random copolymer having
a melt flow rate MFR₂ (230° C./2.16 kg) measured according to ISO 1133 in the range from 4 to 40 g/10 min;
a melting temperature Tm as determined by DSC according to ISO 11357 in the range from 115 to 145° C.; and
a number of 2,1 and 3,1 regio defects in the range from 0.01 to 1.2 mol-% as measured by ¹³C NMR; and wherein
SL and CL1 are polypropylene-based layers.

2. The coated article according to claim 1, characterized in that, CL2 comprises and preferably consists of a polypropylene homopolymer (A) having one or more of the following characteristics:
a number of 2,1 and 3,1 regio defects in the range from 0.01 to 1.2 mo-l%, preferably from 0.4 to 0.85 mol-%, and more preferably from to 0.45 to 0.8 mol-% as measured by ¹³C NMR;
has been produced in the presence of a single-site catalyst, preferably in the presence of a metallocene catalyst;
a melt flow rate MFR² (230° C./2.16 kg) measured according to ISO 1133 in the range from 15 to 37 g/10 min, preferably 20 to 35 g/10 min and a melting temperature Tm as determined by DSC according to ISO 11357 in the range from 150 to 158° C., preferably 153 to 157° C.;
a MWD in the range from 2.5 to 4.5 as determined by GPC;
a xylene cold soluble (XCS) fraction as determined according to ISO 16152 in the range from 0.05 to below 5 wt.-% and preferably 0.1 to 4 wt.-%.

3. The coated article according to claim 1, characterized in that,
CL2 comprises and preferably consists of a polypropylene homopolymer (A), wherein the polypropylene comprises two polymer fractions (PPH-1) and (PPH-2) wherein the split between fractions (PPH-1) and (PPH-2) is in the range from 30:70 to 70:30, preferably 45:55 to 65:35, and more preferably 55:45 to 60:40.

4. The coated article according to claim 1, characterized in that, CL2 comprises and preferably consists of an ethylene propylene random copolymer (B) having one or more of the following characteristics:
has been produced in the presence of a single-site catalyst;
molecular weight distribution MWD as determined by GPC in the range from 2.4 to 5.5, preferably 2.5 to 4.5;
a hexane extractables contents as measured according to the FDA test of less than 2.0 wt.-%, preferably less than 1.5 wt.-%, more preferably 0.1 to 1.5 wt.-%;
a melt flow rate MFR² (230° C./2.16 kg) measured according to ISO 1133 in the range of 17 to 35 g/10 min or 4 to 7 g/10 min, and a melting temperature Tm as determined by DSC according to ISO 11357 of 120 to 140° C.;
a number of 2,1 and 3,1 regio defects in the range from 0.1 to 1.0 mol-% as measured by ¹³C NMR.

5. The coated article according to claim 4, characterized in that,
the ethylene propylene random copolymer (B) is an ethylene propylene random copolymer having an ethylene content in the range from 2.0 to 5.5 wt.-%, or in the range of 2.2 to 4.5 wt.-% based on the weight of the ethylene propylene random copolymer; and/or
the propylene random copolymer (B) has a crystallization temperature T_{c} as determined by DSC according to ISO 11357 in the range from 75 to 110° C., preferably 80 to 105° C.; and/or
the ethylene propylene random copolymer (B) has a xylene cold soluble (XCS) fraction as determined according to ISO 16152 of from 0.1 to below 15 wt.-%; preferably from 0.5 to 5 wt.-% based on the weight of the ethylene propylene random copolymer (B).

6. The coated article according to claim 4, characterized in that,
the ethylene propylene random copolymer (B) comprises, or consists of, two polymer fractions (RACO-1) and (RACO-2) and the split between fractions (RACO-1) and (RACO-2) is preferably from 30:70 to 70:30.

7. The coated article according to claim 1, characterized in that,
the coated article is an extrusion coated article.

8. The coated article according to claim 1, characterized in that,
polypropylene-based layers SL and CL1 contain more than 90 wt.-% polypropylene, preferably from 95 to 100 wt.-% polypropylene, more preferably 99 to 100 wt.-% polypropylene each based on the total weight of the layer and most preferably consist of polypropylene; and/or
preferably the polypropylene in layer SL is a biaxially oriented polypropylene; and/or
the polypropylene in layer CL1 is selected from the group consisting of copolymers and homopolymers of polypropylene and mixtures thereof, preferably the homopolymer (A) or the random copolymer (B), more preferably an heterophasic copolymer.

9. The coated article according to claim 1, characterized in that,
the coated article comprises less than 10 wt.-%, preferably less than 5 wt.-%, more preferably less than 1 wt.-% materials different from polypropylene, still more preferably the coated article consist of polypropylene; and/or
the coated article is not comprising any layers which are not polypropylene-based, preferably the coated article consists of layers SL, CL1 and CL2.

10. The coated article according to claim 1, characterized in that,
CL2 comprises and preferably consists of a polypropylene homopolymer (A) and the sealing initiation temperature of the article is in the range from 105 to 118° C., preferably 110 to 116° C. and more preferably 113 to 115° C.; or
CL2 comprises and preferably consists of an ethylene propylene random copolymer (B) and the sealing initiation temperature of the article is in the range from 60 to 100° C., preferably from 78 to 87° C., more preferably from 80 to 86° C. and still more preferably 81 to 85° C.

11. The coated article according to claim 1, characterized in that,
the total thickness of the coated article is in the range from 10 to 200 μm, preferably from 12 to 170 μm and more preferably in the range from 15 to 100 μm; and/or
the thickness of the layer SL is in the range from 5 to 40 μm, preferably from 10 to 30 μm and more preferably in the range from 15 to 25 μm; and/or
the coating weight of layer CL1 is in the range from 1 to 20 g/m², preferably from 3 to 18 g/m², more preferably from 5 to 15 g/m² and still more preferably from 7 to 12 g/m²; and/or
the coating weight of layer CL2 is in the range from 1 to 20 g/m², preferably from 3 to 18 g/m², more preferably from 5 to 15 g/m² and still more preferably from 7 to 12 g/m².

12. A process for manufacturing a coated article comprising the step of extruding coating layer (CL1) onto the substrate layer to form the coated article according to claim 1.

13. A process for packaging an item comprising the step of enclosing the item, at least in part, in packaging material comprising the coated article according to claim 1.

14. A process for recycling a coated article comprising the step of recycling the coated article according to claim 1 to obtain a recycled polypropylene.

15. The process according to claim 14, characterized in that, the recycled polypropylene is used for manufacturing moulded articles and films.

16. The process according to claim 13, wherein the packaging material is temperature resistant packaging material and the item is food and/or medical products
